(19) United States
(12) Patent Application Publication
(10) Pub. No.: US 2006/0104447 A1
(43) Pub. Date: May 18, 2006

(54) Discrete logarithm-based cryptography using the Shafarevich-Tate group

(75) Inventors: Kristin E. Lauter, La Jolla, CA (US); Anne Kirsten Eisentraeger, Ann Arbor, MI (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/987,394

(22) Filed: Nov. 12, 2004

(51) Int. Cl. H04K 1/00

(52) U.S. Cl. 380/258

(57) ABSTRACT

Systems and methods for discrete logarithm-based cryptography using the Shafarevich-Tate group are described. In one aspect, a Shafarevich-Tate group is generated from an abelian variety. Data is encrypted or signed or a common secret is established as a function of a secret generated from the Shafarevich-Tate group.

### TECHNICAL FIELD

This disclosure relates to discrete log-based cryptography.

### BACKGROUND

As computers have become increasingly commonplace in homes and businesses throughout the world, and such computers have become increasingly interconnected via networks (such as the Internet), security and authentication concerns have become increasingly important. One manner in which these concerns have been addressed is the use of a cryptographic technique involving a key-based cipher. Using a key-based cipher, sequences of intelligible data (typically referred to as plaintext) that collectively form a message are mathematically transformed, through an encryption process, into seemingly unintelligible data (typically referred to as ciphertext). The encryption can be reversed, allowing recipients of the ciphertext with the appropriate key to transform the ciphertext back to plaintext, while making it very difficult, if not nearly impossible, for those without the appropriate key to recover the plaintext.

Public-key cryptographic techniques are one type of key-based cipher. In public-key cryptography, each communicating party has a public/private key pair. The public key of each pair is made publicly available (or at least available to others who are intended to send encrypted communications), but the private key is kept secret. In order to communicate a plaintext message using encryption to a receiving party, an originating party encrypts the plaintext message into a ciphertext message using the public key of the receiving party and communicates the ciphertext message to the receiving party. Upon receipt of the ciphertext message, the receiving party decrypts the message using its secret private key, and thereby recovers the original plaintext message.

Elliptic curve cryptography (ECC) is an approach to public-key cryptography based on mathematics of elliptic curves. Elliptic curve cryptography relies on the difficulty of solving the discrete logarithm problem for the group of points on an elliptic curve over some finite field. For instance, consider an elliptic curve E, a field GF(q), and an abelian group of rational points E(q) of the form (x, y), wherein both x and y are in GF(q), and wherein a group operation “+” is defined on the curve. A second operation “*”|Z×E(q)→E(q) is defined. If P is some point in E(q), then 2*P=P+P,3*P=2*P+P=P+P+P is defined, etc. Given integers j and k, j*(k*P)=(j*k)*P=k*(j*P). The elliptic curve discrete logarithm problem is then, given points P and Q such that k*P=Q, to determine the integer k.

In a conventional key-based cryptographic system (“cryptosystem”), a specific base point G with coordinates (x, y) is selected and published for use with the curve E(q). A private key k is selected as a random integer; and then the value P=k*G (i.e., G added to itself a random number of times) is computed, and used by discrete log-based cryptography method(s) as the public key. If Alice and Bob have private keys k_{A} and k_{B}, and public keys P_{A} and P_{B}, then Alice can calculate k_{A}*P_{B}=(k_{A}*k_{B})*G; and Bob can compute the same value as k_{B}*P_{A}=(k_{B}*k_{A})*G. This allows the establishment of a “secret” value that both Alice and Bob can easily compute, but which is difficult for any third party to derive. Also, Bob does not gain any new knowledge about k_{A} during this transaction, so that Alice's private key remains private.

### SUMMARY

Systems and methods for discrete logarithm-based cryptography using the Shafarevich-Tate group are described. In one aspect, a Shafarevich-Tate group is generated from an abelian variety. Data is encrypted or signed or a common secret is established as a function of a secret generated from the Shafarevich-Tate group.

### BRIEF DESCRIPTION OF THE DRAWINGS

In the Figures, the left-most digit of a component reference number identifies the particular Figure in which the component first appears.

FIG. 1 illustrates an exemplary system for discrete logarithm-based cryptography using the Shafarevich-Tate group.

FIG. 2 shows an exemplary procedure for discrete logarithm-based cryptography using the Shafarevich-Tate group.

FIG. 3 shows an example of a suitable computing environment in which systems and methods for discrete logarithm-based cryptography using the Shafarevich-Tate group may be fully or partially implemented.

### DETAILED DESCRIPTION

Overview

The systems and methods for discrete logarithm-based cryptography using the Shafarevich-Tate group provide Shafarevich-Tate group(s) generated from an elliptic curve E (or an abelian variety such as the Jacobian of a higher genus curve). An element in the Shafarevich-Tate group generated from E(q) is not just a single point P on the curve E(q), but rather, the element may be a collection of local points on the curve (this is one way to represent elements of an Shafarevich-Tate group). The group or composition law associated with each Shafarevich-Tate group (ST-group) is substantially more complex than a group law on an elliptic curve.

It is from an element x in a ST-Group that a user generates a public key. More particularly, the user chooses a random number r that is kept as a secret and composes the publicly known element x of the ST-Group with itself that number of times to determine the users public key. In other words, the user applies the group law in the ST-Group to the publicly known element of the ST-Group its secret number of times to generate its public key. The user's private key is the secret randomly chosen number. The actual methods used to then establish a secret key, encrypt messages, or sign data between first and second parties based on the users' public keys can be a function of any discrete logarithm-based cryptographic protocol such as those employed by Diffie-Hellman, ElGamal discrete log cryptosystem, Digital Signal Algorithm (DSA), etc.

These and other aspects of the invention are now described in greater detail.

An Exemplary System

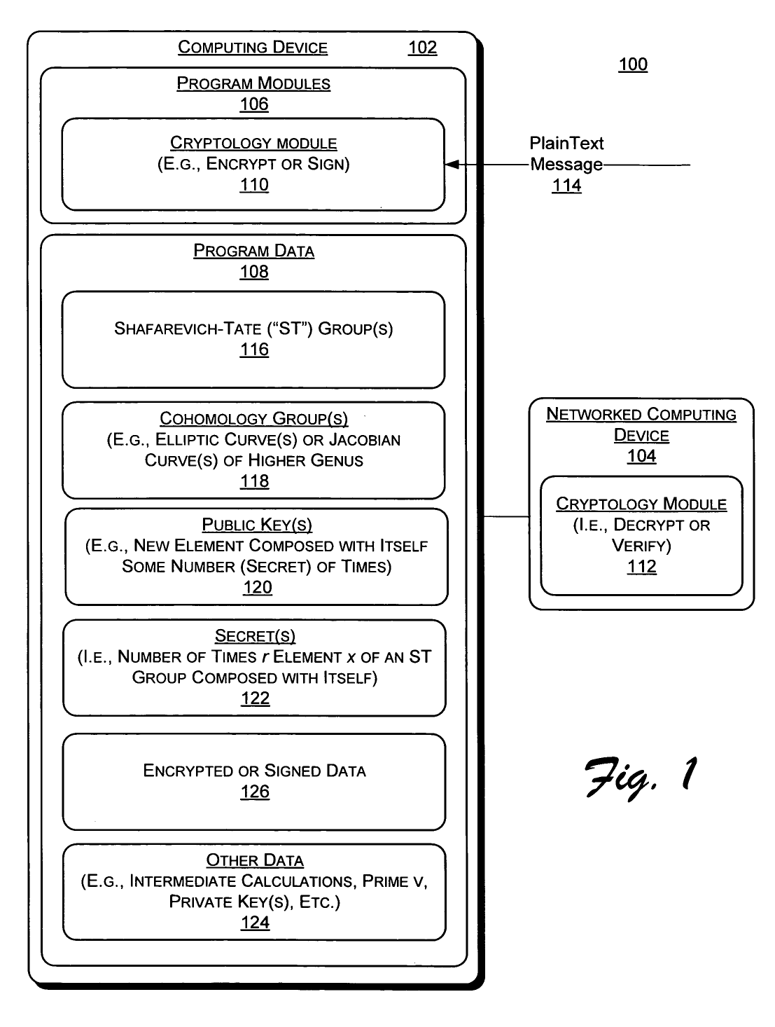

FIG. 1 illustrates an exemplary system 100 for discrete logarithm-based cryptography using the Shafarevich-Tate group. Components of system 100 implement a curve-based cryptographic system (“cryptosystem”) to encrypt or sign data, and subsequently decrypt or verify data using a private key, performing all operations in a Shafarevich-Tate group. Cryptographic protocols implemented in the Shafarevich-Tate group by system 100 include those based on Diffie-Hellman key exchange, DSA, El Gamal encryption, and/or the like.

System 100 includes computing device 102 coupled over a network to a networked computing device 104. Computing device 102 includes program module(s) 106 and program data 108. Program modules 106 include, for example, cryptology module 110. When cryptology module 110 performs public key encryption using generalized El Gamal or Diffie-Hellman key exchange protocols on a Shafarevich-Tate group, cryptology module 110 is an encrypting module. When cryptology module 110 signs data with a digital signature, for example, with DSA operations using a Shafarevich-Tate group, cryptology module 110 is a signing module. Networked computing device also includes program modules and program data, wherein program modules includes a cryptology module 112 which decrypts data encrypted by cryptology module 110 or verifies data signed by cryptology module 110. In view of this, and for purposes of discussion, cryptology module 110 is referred to as encryptor/signer 110 and cryptology module 112 is referred to as decryptor/verifier 112.

In this implementation, encryptor/signer 110 and decryptor/verifier 112 are shown on different computing devices 102 and 104. In another implementation, logic associated with these program modules may be implemented on a single computing device 102.

A Shafarevich-Tate group 116 is a set of objects such as elements in a subgroup of a cohomology group 118. A cohomology is a part of the theory of topology in which groups are used to study the properties of topological spaces and which is related in a complementary way to homology theory, which is also called cohomology theory. A Shafarevich-Tate group 116 provides security to system 100 as a function of the hardness of discrete log in the Shafarevich-Tate group(s) 122. A Shafarevich-Tate group 116 is defined as follows. If K is a number field 118, denote by M_{K} the set of nonequivalent valuations on K. Denote by Kᵥ a completion of K with respect to the metric induced by a prime v and by kᵥ the residue field. In general, if f: G→G′ is a morphism of groups denote its kernel by G_{f}. For a field K and a smooth commutative K-group scheme G, we write Hⁱ(K,G) to denote the group cohomology Hⁱ(Gal(Kₛ/K),G(Kₛ)), where Kₛ is a fixed separable closure of K.

In view of the above, a Shafarevich-Tate group 116 of an abelian variety is defined. Let A be an abelian variety over a number field K. The Shafarevich-Tate group 116 of A, which is defined below, measures the failure of the local-to-global principle for certain torsors. A Shafarevich-Tate group 116 of A over K is

$$III ( A / K ) := Ker ( {H}^{1} ( K , A ) -> {\prod }_{v ∈ {M}_{K}} {H}^{1} ( {K}_{v} , A ) ) .$$

Exemplary Procedure to Use Shafarevich-Tate Group(s) to Encrypt/Sign

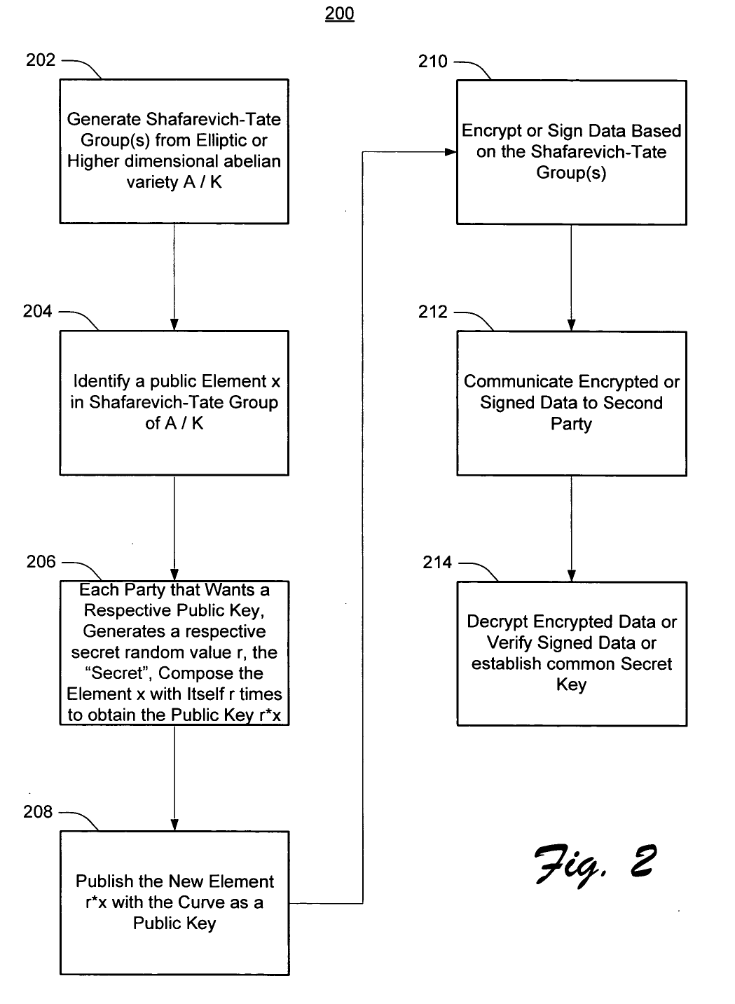

FIG. 2 shows an exemplary procedure 200 to encrypt or sign data in a discrete log-based cryptography algorithm using Shafarevich-Tate group(s). The particular algorithm selected is arbitrary and a function of the particular cryptology architecture selected for implementation. For instance, in one implementation, data is encrypted and decrypted with El Gamal data encryption protocols. In another implementation, data is encrypted and decrypted using techniques based on Diffie-Hellman key exchange protocols. In yet another implementation, data is signed and verified using DSA.

The operations of procedure 200 are described with respect to components of FIG. 1. The left-most digit of a component reference number identifies the particular figure in which the component first appears. For purposes of discussing the operations of procedure 200, a first party A is associated with computer 102 (FIG. 1) and a second party B is associated with computer 104 (FIG. 1). Party A encrypts or signs data and sends the data to party B for corresponding decryption or verification. More particularly, at block 202, encryptor/signer 110 generates Shafarevich-Tate group(s) 116 from an abelian variety A over a number field K, for example an elliptic curve 118 or the Jacobian of a higher genus curve. The security of system 100 is a function of the hardness of discrete log in each Shafarevich-Tate group 116. This is a hard problem. The security of system 100 is also a function of the hardness of discrete log of the elliptic curve E 118 over the local field Kᵥ, which can be related to discrete log of the reduction of the curve \tilde{E} over the residue field kᵥ in the case of good reduction. In view of this, and in this implementation, v is a prime of at least 160 bits to obtain full security.

At block 204, an element x in III(A/K), in the Shafarevich-Tate group 116 of A is identified and made public. In one implementation, the element is selected when the Shafarevich-Tate group is chosen. At block 206, each party that wants to generate a respective public key 120 generates a respective secret random number, r, and composes x with itself in the Shafarevich-Tate group r times to generate a new element (the r^{th} multiple of x, r*x). The number r is a user's (e.g., party A or party B) secret 122. The secret is not shared. At block 208, encryptor/signer 110 publishes this new element as a public key 120. Any two parties (e.g., Alice and Bob) that desire to encrypt or sign a message 114 and/or decrypt or verify associated encrypted or signed data 124, and/or establish a common secret generate respective public keys P 120 (e.g., P_{A} and P_{B}).

At block 210, encryptor/signer 110 encrypts or signs message 114 using the Shafarevich-Tate group(s) 116 to generate encrypted or signed data 126. For example, in one implementation, when cryptology module 110 implements public key encryption using generalized El Gamal protocols on the Shafarevich-Tate group(s) 116, cryptology module 110 encrypts message 114 to generate encrypted data 126.

In another implementation, if cryptology module 110 implements Diffie-Hellman key exchange protocols using the Shafarevich-Tate group(s) 116, cryptology module 110 exchanges public key(s) 120 with cryptology module 112

In yet another implementation, if cryptology module 110 signs data with a digital signature, for example, using DSA operations based on a Shafarevich-Tate group, cryptology module 110 signs message 114 to generate signed data 126.

At block 212, encryptor/signer module 110 communicates encrypted or signed data 126 to another party, for example, party B associated with networked computer 104. At block 214, and responsive to receiving encrypted or signed data 126, decryptor/verifier 112 decrypts or verifies encrypted or signed data 126 using the other party's public key (e.g., party B uses P_{A}, and vice versa) to re-create message 114. More particularly, decryptor/verifier 112 decrypts or verifies encrypted or signed data 126 using decrypting or verifying techniques matching the encrypting or signing techniques used to encrypt or sign message 114. For example, in one implementation, cryptology module 112 decrypts encrypted data 126 using El Gamal operations. In another implementation, cryptology module 112 forms a common secret data 126 using Diffie-Hellman key exchange protocols. In yet another implementation, cryptology module 112 verifies signed data 126 using DSA protocols.

An Exemplary Operating Environment

Although not required, the systems and methods for discrete log-based cryptography using Shafarevich-Tate groups are described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

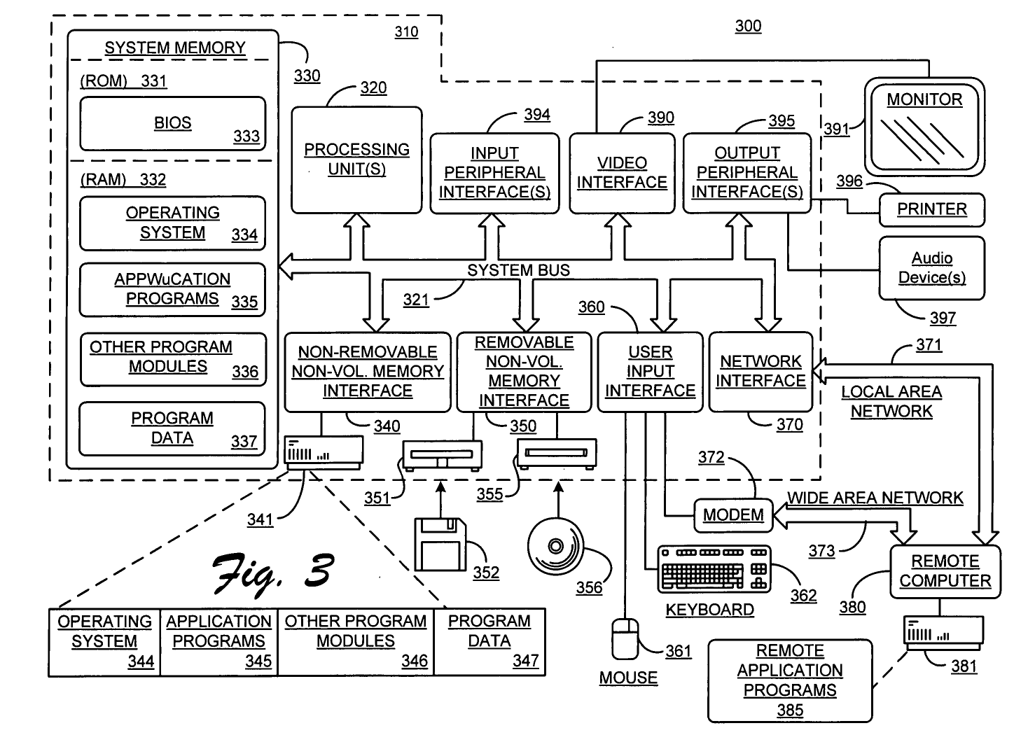

FIG. 3 illustrates an example of a suitable computing environment in which discrete log-based cryptography using Shafarevich-Tate grouping may be fully or partially implemented. Exemplary computing environment 300 is only one example of a suitable computing environment for the exemplary system of FIG. 1 and exemplary operations of FIG. 2, and is not intended to suggest any limitation as to the scope of use or functionality of systems and methods the described herein. Neither should computing environment 300 be interpreted as having any dependency or requirement relating to any one or combination of components illustrated in computing environment 300.

The methods and systems described herein are operational with numerous other general purpose or special purpose computing system, environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 3, an exemplary system for discrete log-based cryptography using Shafarevich-Tate grouping includes a general purpose computing device in the form of a computer 310 implementing, for example, system 100 of FIG. 1. The following described aspects of computer 310 are exemplary implementations of client computing device 102 of FIG. 1. Components of computer 310 may include, but are not limited to, processing unit(s) 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 310 typically includes a variety of computer-readable media. Computer-readable media can be any available media that can be accessed by computer 310 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 310.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example and not limitation, FIG. 3 illustrates operating system 334, application programs 335, other program modules 336, and program data 338.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346, and program data 348. Note that these components can either be the same as or different from operating system 334, application programs 335, other program modules 336, and program data 338. Application programs 335 includes, for example encryptor/signer module 110 and/or decryptor/verifier module 112 of FIG. 1. Program data 338 includes, for example, program data 108 of FIG. 1. Operating system 344, application programs 345, other program modules 346, and program data 348 are given different numbers here to illustrate that they are at least different copies.

A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB).

A monitor 391 or other type of display device is also connected to the system bus 321 via an interface, such as a video interface 390. In addition to the monitor, computers may also include other peripheral output devices such as speakers 398 and printer 396, which may be connected through an output peripheral interface 395.

The computer 310 operates in a networked environment using logical connections to one or more remote computers, such as a remote computer 380. In one implementation, remote computer 350 represent networked computer 104 of FIG. 1. The remote computer 380 may be a personal computer, a server, a router, a network PC, a peer device or other common network node, and as a function of its particular implementation, may include many or all of the elements (e.g., program module(s) 106 and program data 108, etc.) described above relative to the computer 310, although only a memory storage device 381 has been illustrated in FIG. 3. The logical connections depicted in FIG. 3 include a local area network (LAN) 381 and a wide area network (WAN) 383, but may also include other networks. Such networking environments are commonplace in offices, enterprise-wide computer networks, intranets and the Internet.

When used in a LAN networking environment, the computer 310 is connected to the LAN 381 through a network interface or adapter 380. When used in a WAN networking environment, the computer 310 typically includes a modem 382 or other means for establishing communications over the WAN 383, such as the Internet. The modem 382, which may be internal or external, may be connected to the system bus 321 via the user input interface 360, or other appropriate mechanism. In a networked environment, program modules depicted relative to the computer 310, or portions thereof, may be stored in the remote memory storage device. By way of example and not limitation, FIG. 3 illustrates remote application programs 385 as residing on memory device 381. The network connections shown are exemplary and other means of establishing a communications link between the computers may be used.

### CONCLUSION

Although the systems and methods for discrete logarithm-based cryptography using the Shafarevich-Tate group have been described in language specific to structural features and/or methodological operations or actions, it is understood that the implementations defined in the appended claims are not necessarily limited to the specific features or actions described. Rather, the specific features and operations are disclosed as exemplary forms of implementing the claimed subject matter.

1. A method comprising:
generating a Shafarevich-Tate group from an abelian variety; and
encrypting or signing data or establishing a common secret as a function of a secret generated from the Shafarevich-Tate group.

2. A method as recited in claim 1, wherein the abelian variety is an elliptic curve or a Jacobian variety of a higher genus curve.

3. A method as recited in claim 1, wherein encrypting or signing or establishing a common secret is performed with a discrete log-based cryptographic algorithm.

4. A method as recited in claim 1, wherein encrypting is performed with a discrete log-based cryptographic algorithm, the discrete log-based cryptographic algorithm being El Gamal encryption, or establishing a common secret is performed with a discrete log-based cryptographic algorithm, the discrete log-based cryptographic algorithm being Diffie-Hellman key exchange.

5. A method as recited in claim 1, wherein signing is performed with Digital Signature Algorithm.

6. A method as recited in claim 1, wherein encrypting or signing further comprises:
selecting an element x from the Shafarevich-Tate group;
selecting a random number r;
composing the element x, r times with itself to generate a public key; and
wherein r is a maintained as the secret.

7. A method as recited in claim 1, wherein encrypting or signing further comprises:
selecting an element x from the Shafarevich-Tate group;
composing the element x, r times with itself to generate a public key, r being the secret; and
publishing the element x, the public key r*x and the abelian variety so that the data can be decrypted or verified by an independent entity.

8. A method as recited in claim 1, further comprising:
receiving a public key generated from the secret; and
decrypting or verifying the data as a function of the public key.

9. A computer-readable medium comprising computer-program instructions executable by a processor for:
generating a Shafarevich-Tate group from an abelian variety; and
encrypting or signing data or establishing a common secret as a function of a secret generated from the Shafarevich-Tate group.

10. A computer-readable medium as recited in claim 9, wherein the abelian variety is an elliptic curve or a Jacobian variety of a higher genus curve.

11. A computer-readable medium as recited in claim 9, wherein the computer-program instructions for encrypting or signing or establishing a common secret are performed using a discrete log-based cryptographic algorithm.

12. A computer-readable medium as recited in claim 9, wherein the computer-program instructions for encrypting are performed with a discrete log-based cryptographic algorithm, the discrete log-based cryptographic algorithm being El Gamal encryption, or establishing a common secret is performed with a discrete log-based cryptographic algorithm, the discrete log-based cryptographic algorithm being Diffie-Hellman key exchange.

13. A computer-readable medium as recited in claim 9, wherein the computer-program instructions for signing are performed with Digital Signature Algorithm.

14. A computer-readable medium as recited in claim 9, wherein the computer-program instructions for encrypting or signing further comprise instructions for:
selecting an element x from the Shafarevich-Tate group;
selecting a random number r;
composing the element x, r times with itself to generate a public key; and
wherein r is a maintained as the secret.

15. A computer-readable medium as recited in claim 9, wherein the computer-program instructions for encrypting or signing further comprise instructions for:
selecting an element x from the Shafarevich-Tate group;
composing the element x, r times with itself to generate a public key, r being the secret; and
publishing the element x, the public key r*x and the abelian variety so that the data can be decrypted or verified by an independent entity.

16. A computer-readable medium as recited in claim 9, further comprising computer program instructions for:
receiving a public key generated from the secret; and
decrypting or verifying the data as a function of the public key.

17. A computing device comprising:
generating a Shafarevich-Tate group from an abelian variety; and
encrypting or signing data or establishing a common secret as a function of a secret generated from the Shafarevich-Tate group.

18. A computing device as recited in claim 17, wherein the abelian variety is an elliptic curve or a Jacobian variety of a higher genus curve.

19. A computing device as recited in claim 17, wherein the computer-program instructions for encrypting or signing or establishing a common secret are performed using a discrete log-based cryptographic algorithm.

20. A computing device as recited in claim 17, wherein the computer-program instructions for encrypting are performed with a discrete log-based cryptographic algorithm, the discrete log-based cryptographic algorithm being El Gamal encryption, or establishing a common secret is performed with a discrete log-based cryptographic algorithm, the discrete log-based cryptographic algorithm being Diffie-Hellman key exchange.

21. A computing device as recited in claim 17, wherein the computer-program instructions for signing are performed with Digital Signature Algorithm.

22. A computing device as recited in claim 17, wherein the computer-program instructions for encrypting or signing further comprise instructions for:
selecting an element x from the Shafarevich-Tate group;
selecting a random number r;
composing the element x, r times with itself to generate a public key; and
wherein r is a maintained as the secret.

23. A computing device as recited in claim 17, wherein the computer-program instructions for encrypting or signing further comprise instructions for:
selecting an element x from the Shafarevich-Tate group;
composing the element x, r times with itself to generate a public key, r being the secret; and
publishing the element x, the public key r*x and the abelian variety so that the data can be decrypted or verified by an independent entity.

24. A computing device as recited in claim 17, further comprising computer program instructions for:
receiving a public key generated from the secret; and
decrypting or verifying the data as a function of the public key.

25. A computing device comprising:
generating means to generate a Shafarevich-Tate group from an abelian variety; and
encrypting or signing means to encrypt or sign data or establish a common secret as a function of a secret generated from the Shafarevich-Tate group.

26. A computing device as recited in claim 25, wherein the abelian variety is an elliptic curve or a Jacobian variety of a higher genus curve.

27. A computing device as recited in claim 25, wherein the encrypting or signing or establishing means respectively encrypt or sign or establish a common secret using a discrete log-based cryptographic algorithm.

28. A computing device as recited in claim 25, wherein the signing means uses Digital Signature Algorithm.

29. A computing device as recited in claim 17, wherein the encrypting or signing means further comprise:
selecting means to select an element x from the Shafarevich-Tate group;
selecting means to obtain a random number r;
composing means to compose the element x, r times with itself to generate a public key; and
wherein r is a maintained as the secret.

30. A computing device as recited in claim 25, wherein the encrypting or signing means further comprise:
selecting means to select an element x from the Shafarevich-Tate group;
composing means to compose the element x, r times with itself to generate a public key, r being the secret; and
publishing means to publish the element x, the public key r*x and the abelian variety so that the data can be decrypted or verified by an independent entity.

31. A computing device as recited in claim 25, further comprising:
receiving means to receive a public key generated from the secret; and
decrypting or verifying means to respectively decrypt or verify the data as a function of the public key.
